(19) United States
(12) Patent Application Publication
(10) Pub. No.: US 2024/0088725 A1
(43) Pub. Date: Mar. 14, 2024

(54) ELECTRONIC DEVICE AND METHOD FOR WIRELESS COMMUNICATION

(71) Applicant: GLS CO., LTD., Daejeon (KR)

(72) Inventors: Ki Dong SONG, Daejeon (KR); Ki Chan EUN, Daejeon (KR); Hye Min LEE, Sejong-si (KR); Won Ki JU, Daejeon (KR)

(73) Assignee: GLS CO., LTD., Daejeon (KR)

(21) Appl. No.: 18/269,129

(22) PCT Filed: Dec. 24, 2020
(86) PCT No.: PCT/KR2020/019084

§ 371 Date: Jun. 22, 2023

(30) Foreign Application Priority Data
Dec. 24, 2020 (KR) 10-2020-0182790

(51) Int. Cl. H02J 50/80; G08C 17/02; H02J 50/10; H02J 50/20

(52) U.S. Cl. CPC H02J 50/80; G08C 17/02; H02J 50/10; H02J 50/20

(57) ABSTRACT

An electronic device and method for wireless communication are proposed. The method for wireless communication includes an operation of converting a control signal received from an external device into a second RF signal having a second frequency band, an operation of transmitting and/or receiving the second RF signal, an operation of reconverting the second RF signal into the control signal, an operation of converting, by a transmitter, a data signal into a first RF signal having a first frequency band different from the second frequency band on a basis of the control signal, an operation of transmitting and/or receiving the first RF signal, an operation of converting, by a receiver, the received first RF signal into the data signal, and an operation of wirelessly transmitting and/or receiving electric power by the transmitter and the receiver.

### TECHNICAL FIELD

Various exemplary embodiments of the present disclosure relate to a device and method for high-speed wireless communication and wireless power transmission.

### BACKGROUND ART

As for interface methods for data transmission in electronic devices, various interfaces are commercialized in addition to Universal Serial Bus (USB), Thunderbolt, Digital Video Interface (DVI), High Definition Multimedia Interface (HDMI), DisplayPort, and V-by-One, which are interfaces based on wired communication.

In particular, with the recent introduction and commercialization of a USB Type-C standard interface (hereinafter, referred to as a USB Type-C interface), various electronic devices including this USB Type-C interface are being developed and introduced. Such an interface is generally implemented with wired communication, and is also technically easy to implement. However, recently, demand for increases in data capacity and data transmission speed for data to be transmitted between electronic devices is growing exponentially. In addition, the need for high-speed wireless communication supporting USB Type-C, in which such communication is desired to be performed wirelessly, is increasing so that the portability electronic devices and the accessibility of users are improved.

Moreover, in addition to the communication transmission function, the USB Type-C has a Power Delivery (PD) function capable of supplying electric power from a host electronic device to electronic equipment for devices. By using this PD function, the electronic equipment for devices has convenience of not having to use a separate power supply cable except for a USB type-C cable connected to the host electronic device. However, in a case when the communication function of USB type-C interface is replaced with a wireless communication function, the power supply function also needs to be provided wirelessly.

### DISCLOSURE

### Technical Problem

The USB type-C interface has functions of USB data communication, image information communication for Display Port (DP), and power transmission. Such a USB type-C interface was developed to be used with a cable composed of wire bundles.

However, when a wired USB Type-C cable is used for mobile electronic devices (e.g., smartphones, AR/VR devices, etc.), there is inconvenience that the corresponding cable should always be carried and manually connected by a user. To avoid such inconvenience, it is required to make the USB type-C interface wireless.

In order to support the wireless USB type-C interface, all the functions of USB data communication, image information transmission for DP, and power transmission should be replaced with wireless communication and wireless power transmission, and the present disclosure relates to this subject matter.

### Technical Solution

According to an exemplary embodiment, there is provided a method for wireless communication, the method including: an operation of converting a control signal received from an external device into a second RF signal having a second frequency band; an operation of transmitting and/or receiving the second RF signal; an operation of reconverting the second RF signal into the control signal; an operation of converting, by a transmitter, a data signal into a first RF signal having a first frequency band different from the second frequency band on a basis of the control signal; an operation of transmitting and/or receiving the first RF signal; an operation of converting, by a receiver, the received first RF signal into the data signal; and an operation of wirelessly transmitting and/or receiving electric power by the transmitter and the receiver.

According to the exemplary embodiment, there is provided an electronic device including a transmitter and a receiver, the electronic device including: a first communication channel for transmitting and receiving a first RF signal of a first frequency band between the transmitter and the receiver; a second communication channel for transmitting and receiving a second RF signal of a second frequency band different from the first frequency band between the transmitter and the receiver; and a third communication channel for transmitting and receiving electric power between the transmitter and the receiver, wherein the first communication channel may include: a first converter for converting, by the transmitter, a data signal into a digital signal; a first radio frequency integrated circuit (RFIC) for converting the digital signal into the first RF signal and transmitting the first RF signal; a second RFIC for receiving, by the receiver, the first RF signal and converting the first RF signal into the digital signal; and a second converter for converting the digital signal into the data signal, and the second communication channel may include: a third RFIC for converting, by the transmitter, a control signal into the second RF signal and transmitting the second RF signal; and a fourth RFIC for receiving, by the receiver, the second RF signal and converting the second RF signal into the control signal.

According to the exemplary embodiment, a first communication channel may be a communication channel for transmitting and receiving control signals for controlling each electronic device, and a second communication channel may be used for communication purposes for data transmission and reception to transmit a large amount of data at high speed according to control signals of the first communication channel. In this case, the first communication channel may be configured as a low-speed communication channel for transmitting and receiving low-capacity control signals, and the second communication channel may be configured as a high-speed communication channel for transmitting the large amount of data. In this case, the first frequency band may include a band ranging from 30 GHz to 300 GHz band, and the second frequency band may include a band ranging from 3 GHz to 30 GHz, and the first and second communication channels may use frequency bands different from each other, or may be allowed to use the same frequency band in the two communication channels. According to the exemplary embodiment, the third communication channel may be used as a communication channel for power transmission between the electronic devices.

### Advantageous Effects

The present disclosure relates to a device for performing data transmission and reception and electric power transmission and reception in an electronic device by using wireless communication.

In addition, the embodiment of the present disclosure uses a signal of a millimeter wave (mmWave) frequency band to transmit and receive the signal of the electronic device, whereby high-volume data may be transmitted and received in real time.

In addition, the embodiment of the present disclosure transmits and receives high-volume data wirelessly and simultaneously transmits and receives electric power wirelessly, whereby data communication and power charging may be simultaneously performed.

In addition, the embodiment of the present disclosure uses a signal of an extreme frequency band to transmit and receive the signal of the electronic device, whereby high-volume data may be transmitted and received at high speed.

In addition, the embodiment of the present disclosure transmits and receives a control signal and a communication signal on the basis of wireless communication, whereby a degree of freedom for a user's movement may be secured.

In addition, the embodiment of the present disclosure does not use a data protocol for separate wired transmission, and immediately converts high-speed data into a format capable of mmWave transmission to transmit or receive the high-speed data. Therefore, as a result, no additional hardware or controller is required to convert a wired transmission format back to the mmWave form, whereby transmission efficiency may be maximally increased.

The effects that may be obtained in various exemplary embodiments of the present disclosure are not limited to the above-mentioned effects, and other different effects that are not mentioned herein will be clearly understood by those skilled in the art from the following description.

### DESCRIPTION OF DRAWINGS

FIG. 1 is a view illustrating a communication structure according to an exemplary embodiment.

FIG. 2 a view illustrating a communication structure in which a data signal is converted into a wireless signal and communicated according to the exemplary embodiment.

### MODE FOR INVENTION

Advantages and features of the exemplary embodiments of the present disclosure and the methods of achieving the same will become apparent with reference to the exemplary embodiments described below in detail in conjunction with the accompanying drawings. However, the present disclosure is not limited to the exemplary embodiments disclosed below, but will be implemented in a variety of different forms. These exemplary embodiments are provided only to complete the embodiments of the present disclosure and to completely inform the scope of the present disclosure to those skilled in the art to which the present disclosure pertains, and the present disclosure is only defined by the scope of the claims. Like reference numerals generally denote like elements throughout the present specification.

In the following descriptions of the exemplary embodiments of the present disclosure, it is to be noted that, when a detailed description of a known function or configuration may unnecessarily obscure the subject matter of the present disclosure, the detailed description thereof will be omitted. In addition, terms to be described later are terms defined in consideration of functions in the exemplary embodiments of the present disclosure, and the terms may vary according to the intention or custom of users or operators. Therefore, definitions of these terms should be made on the basis of the content throughout the present specification.

Hereinafter, exemplary embodiments of the present disclosure will be described in detail with reference to the accompanying drawings.

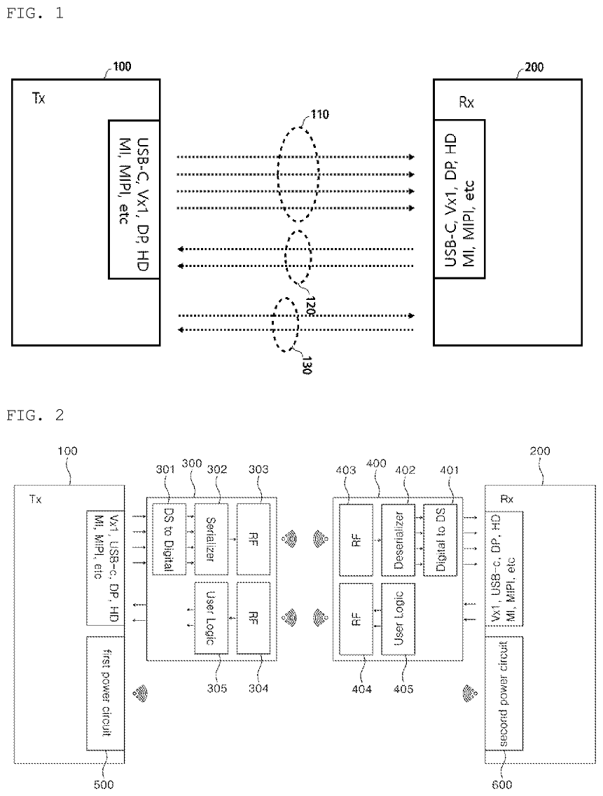

FIG. 1 is a view illustrating a communication structure according to an exemplary embodiment.

Referring to FIG. 1, the communication structure according to the exemplary embodiment may include: a transmitter 100 (e.g., V-by-One (Vx1) Tx or Universal Serial Bus (USB) type-C Tx); and a receiver 200 (e.g., Vx1 Rx or Universal Serial Bus (USB) type-C Rx).

According to the exemplary embodiment, the transmitter 100 may be a part of an electronic device (e.g., a smart phone, a home appliance, or a wearable device) connected to a wearable device. According to another exemplary embodiment, the transmitter 100 may be at least a part of a USB type-C connector.

According to the exemplary embodiment, the receiver 200 may be at least a part of a wearable display device supporting augmented reality (AR), virtual reality (VR), or mixed reality (MR). According to another exemplary embodiment, the receiver 200 may be at least a part of a connector connected to a USB type-C connector, but the transmitter 100 and the receiver 200 are not limited to the above-described examples.

According to the exemplary embodiment, the transmitter 100 and the receiver 200 may be operatively connected to each other. According to the exemplary embodiment, the transmitter 100 and the receiver 200 may be connected to each other wirelessly through a wireless communication protocol. According to the exemplary embodiment, the transmitter 100 and the receiver 200 may be connected to each other through a first communication channel 110, a second communication channel 120, and a third communication channel 130. For example, the transmitter 100 and the receiver 200 may be operatively connected to each other through mmWave communication and/or Ultra-wideband (UWB) communication, but is not limited thereto.

According to the exemplary embodiment, the transmitter 100 and the receiver 200 may transmit and/or receive a first signal (e.g., a mmWave signal) of a first frequency band including 30 GHz to 300 GHz through the first communication channel 110. According to the exemplary embodiment, the transmitter 100 and the receiver 200 may transmit and received a second signal (e.g., a UWB signal) of a second frequency band including 3 GHz to 30 GHz lower than those of the first frequency band through the second communication channel 120. According to the exemplary embodiment, the transmitter 100 and the receiver 200 may transmit and receive high-volume data through the first communication channel 110, and may transmit and receive low-volume data through the second communication channel 120. For example, the first communication channel 110 may form a main link for transmitting and receiving the high-volume data, and the second communication channel 120 may form an auxiliary link for transmitting and receiving auxiliary signals (e.g., LOCKN, HTPDN), but are not limited thereto.

According to the exemplary embodiment, the transmitter 100 and the receiver 200 may transmit and receive electric power through the third communication channel 130. According to the exemplary embodiment, the transmitter 100 and the receiver 200 may wirelessly transmit and/or receive the electric power through the third communication channel 130. For example, each of the transmitter 100 and the receiver 200 may include at least one coil, and transmit and receive the electric power wirelessly by contacting each other, so that each coil is adjacent to each other. For another example, the transmitter 100 and the receiver 200 may modulate a power signal into a wireless communication signal, and transmit and receive the wireless communication signal. A detailed description thereof will be given later.

According to the exemplary embodiment, the transmitter 100 may transmit the first signal to the receiver 200. According to the exemplary embodiment, the transmitter 100 may transmit the first signal to the receiver 200 through the first communication channel 110. For example, the transmitter 100 may transmit a signal of the mmWave frequency band to the receiver 200 through the first communication channel 110. According to another exemplary embodiment (not shown), the receiver 200 may transmit the first signal to the transmitter 100 through the first communication channel 110. Directions for transmitting and receiving signals through the first communication channel 110 are not limited to the above examples.

According to the exemplary embodiment, the receiver 200 may transmit the second signal to the transmitter 100. According to the exemplary embodiment, the receiver 200 may transmit the second signal to the transmitter 100 through the second communication channel 120. For example, the receiver 200 may transmit a signal of the UWB frequency band (3 GHz to GHz) to the transmitter 100 through the second communication channel 120. According to another exemplary embodiment (not shown), the transmitter 100 may transmit the second signal to the receiver 200 through the second communication channel 110. Directions for transmitting and receiving signals through the second communication channel 120 are not limited to the above examples. For example, in the transmission and/or reception of signals, the roles of the transmitter 100 and the receiver 200 may be interchanged to enable two-way communication.

According to the exemplary embodiment, transmission and/or reception of the first signal through the first communication channel 110 may be controlled by the second signal. For example, the transmitter 100 may transmit the first signal to the receiver 200 through the first communication channel 110 on the basis of the second signal received from the receiver 200. For another example, the transmitter 100 may receive the first signal from the receiver 200 through the first communication channel 110 on the basis of the second signal received from the receiver 200.

According to the exemplary embodiment, the transmitter 100 and the receiver 200 may perform the transmission and reception of the first signal and the second signal through the first communication channel 110 and the second communication channel 120, and at the same time, may perform the transmission and reception of electric power through the third communication channel 130. For example, while the transmitter 100 transmits the first signal through the first communication channel 110, the receiver 200 may transmit the electric power to the transmitter 100 through the third communication channel 130. However, the forms of communication are not limited to the above examples.

FIG. 2 a view illustrating a communication structure in which a data signal is converted into a wireless signal and communicated according to the exemplary embodiment.

Referring to FIGS. 1 and 2 together, the communication structure according to the exemplary embodiment may include: a transmitter 100; a first wireless communication circuit 300 coupled to the transmitter 100; a first power circuit 500 disposed in the transmitter 100; a receiver 200; a second power circuit 600 disposed in the receiver 200; and a second wireless communication circuit 400 coupled to the receiver 200. The same reference numerals are used for substantially the same components as those described above, and duplicate descriptions are omitted.

According to the exemplary embodiment, a data signal may be a USB signal including a USB interface. According to another exemplary embodiment, the data signal may be a display port (DP) signal including a display signal, but is not limited thereto.

According to the exemplary embodiment, the first wireless communication circuit 300 may include a first converter 301, a serialization circuit 302, a first radio frequency integrated circuit (RFIC) 303, and a third RFIC 304, and a first user logic 305.

According to the exemplary embodiment, the second wireless communication circuit 400 may include a second converter 401, a deserialization circuit 402, a second RFIC 403, a fourth RFIC 404, and a second user logic 405.

According to the exemplary embodiment, the first wireless communication circuit 300 and the second wireless communication circuit 400 may perform millimeter wave communication through the first communication channel (e.g., the first communication channel 110 of FIG. 1), and may perform UWB communication through the second communication channel (e.g., the second communication channel 120 of FIG. 1), but are not limited thereto.

According to the exemplary embodiment, the first communication channel may include a first converter 301, a serialization circuit 302, a first RFIC 303, a second RFIC 403, a deserialization circuit 402, and a second converter 401.

According to the exemplary embodiment, the serialize circuit 302 and the deserialization circuit 402 may be replaced and used with a digital signal processor (DSP) circuit.

According to the exemplary embodiment, the first converter 301 may receive a data signal, having a designated interface (e.g., USB-C or DP), from the transmitter 100. For example, the data signal may include a differential signal (DS), but is not limited thereto. According to the exemplary embodiment, the first converter 301 may convert the data signal received from the transmitter 100 into a digital signal. The first converter 301 may convert the data signal into the digital signal and transmit the digital signal to the serialization circuit 302.

According to the exemplary embodiment, the serialization circuit 302 may serialize the digital signal received from the first converter 301. According to the exemplary embodiment, the serialization circuit 302 may serialize the digital signal received through the first converter 301 so as to be suitable for radio frequency (RF) communication. For example, the serialization circuit 302 may convert 10-bit parallel data received through the first converter 301 into serial data.

According to the exemplary embodiment, the first RFIC 303 may convert a signal received from the serialization circuit 302 into a first RF signal and broadcast the signal. The first RFIC 303 may convert the signal received from the serialization circuit 302 into the first RF signal, which is used in a first network (e.g., a mmWave network) and transmitted and received through the first communication channel. For example, the first RFIC 303 may convert a signal received from the serialization circuit 302 into a signal of a mmWave band including 30 GHz to 300 GHz, but the frequency band is not necessarily limited thereto. According to the exemplary embodiment, the first RFIC 303 may transmit the first RF signal to the second RFIC 403.

According to the exemplary embodiment, the second RFIC 403 may receive the first RF signal from the first RFIC 303. According to the exemplary embodiment, the second RFIC 403 may convert the first RF signal received from the first RFIC 303 into serial data. The second RFIC 403 may convert the first RF signal received from the first RFIC 303 into the serial data and provide the serial data to the deserialization circuit 402.

According to the exemplary embodiment, the deserialization circuit 402 may parallelize the serial data. According to the exemplary embodiment, the deserialization circuit 402 may convert the serial data received through the second RFIC 403 into 10-bit parallel data.

According to the exemplary embodiment, the second converter 401 may receive the parallel data from the deserialization circuit 402. The second converter 401 may convert a digital signal into a data signal and transmit the data signal to the receiver 200. The second converter 401 may convert the parallel data received from the deserialization circuit 402 into a data signal having a designated interface (e.g., Vx1, DVI, USB-C, or DP). For example, the data signal may include a differential signal (DS), but is not limited thereto.

According to the exemplary embodiment, the second communication channel may include a third RFIC 304, a fourth RFIC 404, a first user logic 305, and a second user logic 405.

According to the exemplary embodiment, the first user logic 305 and the second user logic 405 may be timing controllers, but are not limited thereto. For example, the receiver 200 may transmit control data and timing data to the second user logic 405.

According to the exemplary embodiment, the second user logic 405 may receive a control signal from the receiver 200. The second user logic 405 may provide the control signal to the fourth RFIC 404. For example, the second user logic 405 may transmit the control signal received from the receiver 200 to the fourth RFIC 404. According to another exemplary embodiment (not shown), the second user logic 405 may modulate a control signal received from the receiver 200 and transmit the modulated control signal to the fourth RFIC 404.

According to the exemplary embodiment, the fourth RFIC 404 may convert the control signal received from the second user logic 405 into a second RF signal. The fourth RFIC 404 may convert the control signal into the second RF signal, which is used in a second network (e.g., a UWB network) and transmitted and received through the second communication channel. The fourth RFIC 404 may provide the converted second RF signal to the third RFIC 304. For example, the fourth RFIC 404 may convert a signal received from the second user logic 405 into a signal of a UWB band including 3 GHz to 30 GHz. The fourth RFIC 404 may transmit the second RF signal to the third RFIC 304.

According to the exemplary embodiment, the third RFIC 304 may receive the second RF signal from the fourth RFIC 404. According to the exemplary embodiment, the third RFIC 304 may convert the second RF signal received from the fourth RFIC 404 into a control signal. The third RFIC 304 may convert the second RF signal received from the fourth RFIC 404 into the control signal and provide the control signal to the first user logic 305.

According to the exemplary embodiment, the first user logic 305 may provide the control signal received from the third RFIC 304 to the transmitter 100.

According to the exemplary embodiment, the first power circuit 500 may be connected to the second power circuit 600 wirelessly. The first power circuit 500 may be electromagnetically connected to the second power circuit 600. According to the exemplary embodiment, each of the first power circuit 500 and the second power circuit 600 may include at least one coil. For example, each of the first power circuit 500 and the second power circuit 600 includes a coil for wireless power transmission, and the transmitter 100 and the receiver 200 contact each other so that its coils are adjacent to each other, whereby electric power may be transmitted and/or received wirelessly. The first power circuit 500 and the second power circuit 600 use electromagnetic induction so that the electric power may be wirelessly transmitted and received. The first power circuit 500 and the second power circuit 600 generate magnetic flux by flowing an alternating current (AC) in the coil on one side, and generate an electromotive force in the coil on the other side through the generated magnetic flux, so that electric power may be transmitted and received.

According to another exemplary embodiment, each of the first power circuit 500 and the second power circuit 600 may include an antenna, and modulate a power signal into a wireless communication signal through the antenna. For example, each of the first power circuit 500 and the second power circuit 600 includes the antenna, and may transmit and receive electric power by converting an AC radio wave waveform into a direct current (DC) through a rectifier circuit through respective antennas.

According to a yet another exemplary embodiment, each of the first power circuit 500 and the second power circuit 600 may include an inductor and a capacitor. For example, each of the first power circuit 500 and the second power circuit 600 may include an LC circuit, and transmit electric power by matching resonant frequencies of an electric field or a magnetic field. However, a power transmission method between the first power circuit 500 and the second power circuit 600 is not limited to the above examples, and the electric power may be transmitted and received in various methods.

According to the exemplary embodiment, a method for wireless communication may include: an operation of converting a control signal received from an external device into a second RF signal having a second frequency band; an operation of transmitting and/or receiving the second RF signal; an operation of reconverting the second RF signal into the control signal; an operation of converting, by a transmitter, a data signal into a first RF signal having a first frequency band different from the second frequency band on the basis of the control signal; an operation of transmitting and/or receiving the first RF signal; an operation of converting, by a receiver, the received first RF signal into the data signal; and an operation of wirelessly transmitting and/or receiving electric power by the transmitter and the receiver. According to the exemplary embodiment, the operation of converting of the data signal into the first RF signal may include an operation of serializing data of the data signal, and the operation of converting the first RF signal into the data signal may include an operation of deserializing data of the first RF signal.

According to the exemplary embodiment, the method for wireless communication may include an operation of wirelessly transmitting and/or receiving electric power through a plurality of coils.

According to the exemplary embodiment, the first frequency band may include the band of 30 GHz to 300 GHz, and the second frequency band may include the band of 3 GHz to 30 GHz.

According to the exemplary embodiment, in the method for wireless communication, the transmitter and the receiver may wirelessly transmit and/or receive electric power while transmitting and/or receiving the first RF signal.

According to the exemplary embodiment, a data signal may include a signal of USB, DP, or HDMI, and the method for wireless communication may further include an operation of receiving the data signal through a connector of USB, DP, or HDMI.

According to the exemplary embodiment, an electronic device including a transmitter and a receiver may include: a first communication channel for transmitting and receiving a first RF signal of a first frequency band between the transmitter and the receiver; a second communication channel for transmitting and receiving a second RF signal of a second frequency band different from the first frequency band between the transmitter and the receiver; and a third communication channel for transmitting and receiving electric power between the transmitter and the receiver, wherein the first communication channel may include: a first converter for converting, by the transmitter, a data signal into a digital signal; a first radio frequency integrated circuit (RFIC) for converting the digital signal into the first RF signal and transmitting the first RF signal; a second RFIC for receiving, by the receiver, the first RF signal and converting the first RF signal into the digital signal; and a second converter for converting the digital signal into the data signal, and the second communication channel may include: a third RFIC for converting, by the transmitter, a control signal into the second RF signal and transmitting the second RF signal; and a fourth RFIC for receiving, by the receiver, the second RF signal and converting the second RF signal into the control signal.

According to the exemplary embodiment, the transmission and/or reception of the first RF signal through the first communication channel may be performed on the basis of the control signal.

According to the exemplary embodiment, the third communication channel may include the first power circuit disposed in the transmitter and the second power circuit disposed in the receiver.

According to the exemplary embodiment, each of the first power circuit and the second power circuit may include at least one coil for wireless power transmission.

According to the exemplary embodiment, the third RFIC may include the serialization circuit for converting the digital signal into the first RF signal, and the fourth RFIC may include the deserialization circuit for converting the first RF signal into the digital signal.

According to the exemplary embodiment, the electronic device may transmit and/or receive electric power through the third communication channel while transmitting and/or receiving the first RF signal through the first communication channel.

According to the exemplary embodiment, the electronic device may further include the connector of USB, DP, or HDMI for wired connection.

According to the exemplary embodiment, the data signal may include the signal of USB, DP, or HDMI.

In the above description, various exemplary embodiments of the present disclosure have been presented and described, but the present disclosure is not necessarily limited thereto, and those skilled in the art to which the present disclosure pertains will readily recognize that various substitutions, modifications, and changes are possible within the scope of the technical spirit of the present disclosure.

1. A method for wireless communication, the method comprising:
an operation of converting a control signal received from an external device into a second RF signal having a second frequency band;
an operation of transmitting and/or receiving the second RF signal;
an operation of reconverting the second RF signal into the control signal;
an operation of converting, by a transmitter, a data signal into a first RF signal having a first frequency band different from the second frequency band on a basis of the control signal;
an operation of transmitting and/or receiving the first RF signal;
an operation of converting, by a receiver, the received first RF signal into the data signal; and
an operation of wirelessly transmitting and/or receiving electric power by the transmitter and the receiver.

2. The method of claim 1, wherein the operation of converting the data signal into the first RF signal comprises an operation of serializing data of the data signal, and
the operation of converting the first RF signal into the data signal comprises an operation of deserializing data of the first RF signal.

3. The method of claim 1, further comprising:
an operation of wirelessly transmitting and/or receiving the electric power through a plurality of coils.

4. The method of claim 1, wherein the first frequency band comprises a band of 30 GHz to 300 GHz, and
the second frequency band comprises a band of 3 GHz to 30 GHz.

5. The method of claim 1, wherein the transmitter and the receiver wirelessly transmits and/or receives the electric power while the first RF signal is transmitted and/or received.

6. The method of claim 1, further comprising:
an operation of receiving the data signal through a USB connector, the data signal comprising a USB signal.

7. The method of claim 1, further comprising:
an operation of receiving the data signal through a connector of DP or HDMI, the data signal comprising a signal of DP or HDMI.

8. An electronic device comprising a transmitter and a receiver, the electronic device comprising:
a first communication channel for transmitting and receiving a first RF signal of a first frequency band between the transmitter and the receiver;
a second communication channel for transmitting and receiving a second RF signal of a second frequency band different from the first frequency band between the transmitter and the receiver; and
a third communication channel for transmitting and receiving electric power between the transmitter and the receiver,
wherein the first communication channel comprises:
a first converter for converting, by the transmitter, a data signal into a digital signal;
a first radio frequency integrated circuit (RFIC) for converting the digital signal into the first RF signal and transmitting the first RF signal;
a second RFIC for receiving, by the receiver, the first RF signal and converting the first RF signal into the digital signal; and
a second converter for converting the digital signal into the data signal, and
the second communication channel comprises:
a third RFIC for converting, by the transmitter, a control signal into the second RF signal and transmitting the second RF signal; and
a fourth RFIC for receiving, by the receiver, the second RF signal and converting the second RF signal into the control signal.

9. The electronic device of claim 8, wherein the transmitting and/or receiving of the first RF signal through the first communication channel is performed on a basis of the control signal.

10. The electronic device of claim 8, wherein the third communication channel comprises:
a first power circuit disposed in the transmitter; and
a second power circuit disposed in the receiver.

11. The electronic device of claim 10, wherein each of the first power circuit and the second power circuit comprises at least one coil for wireless power transmission.

12. The electronic device of claim 8, wherein the third RFIC comprises a serialization circuit for converting the digital signal into the first RF signal, and
the fourth RFIC comprises a deserialization circuit for converting the first RF signal into the digital signal.

13. The electronic device of claim 8, wherein the electric power is transmitted and/or received through the third communication channel while the first RF signal is transmitted and/or received through the first communication channel.

14. The electronic device of claim 8, further comprising:
a connector of USB, DP, or HDMI for wired connection.

15. The electronic device of claim 8, wherein the data signal comprises a signal of the USB, DP, or HDMI.
